(19) United States
(12) Patent Application Publication
(10) Pub. No.: US 2024/0221091 A1
(43) Pub. Date: Jul. 4, 2024

(54) MACHINE LEARNING-ASSISTED USER REPORTING AND MODERATION OF MULTIMEDIA CONTENT

(71) Applicant: Microsoft Technology Licensing, LLC, Redmond, WA (US)

(72) Inventors: Sayak Dey, Bangalore (IN); Abhishek Maiti, Kolkata (IN); Sourav Kumar Bose, Mahamayatala (IN); Smitkumar Narotambhai Marvaniya, Bangalore (IN); Rajesh Hariharan, Fremont, CA (US); Charles M. Voelkel, San Jose, CA (US); Vipin Gupta, Bengaluru (IN); Vidit Jain, Bangalore (IN)

(21) Appl. No.: 18/150,167

(22) Filed: Jan. 4, 2023

(51) Int. Cl. G06Q 50/00; G06N 5/022

(52) U.S. Cl. CPC G06Q 50/01; G06N 5/022

(57) ABSTRACT

Embodiments of technologies for machine learning-assisted content moderation include receiving a first electronic communication from a user device, where the first electronic communication identifies a content item. At least one trained machine learning model is selected from a set of trained machine learning models based on the content item and the first electronic communication. The selected trained machine learning model(s) are applied to the identified content item. The selected trained machine learning model(s) identify sub-items of the content item, corresponding content labels, and associated confidence metrics. Using the confidence metrics and one or more additional electronic communications received from the user device, a content moderation process is applied to the content item and/or the sub-items.

### TECHNICAL FIELD

This disclosure relates to the technical field of online systems, including digital content distribution. Another technical field to which this disclosure relates is digital content moderation.

### BACKGROUND

Online platforms, such as social graph applications or social media platforms, receive and distribute millions of items of digital content from user devices and other sources. As online platforms operate with an increasingly global user base, the online platforms are expected to be able to manage increasing amounts of content with varying levels of suitability across many different audiences.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system 100 that includes a content moderation system 150 in accordance with some embodiments of the present disclosure.

FIG. 2 is a flow diagram of an example method 200 to select machine learning models and perform content moderation using content sub-items, in accordance with some embodiments of the present disclosure.

FIG. 3 is an example of a machine learning-assisted content moderation process 300, in accordance with some embodiments of the present disclosure.

FIG. 4 is an example of an image segmentation model-based content moderation process 400, in accordance with some embodiments of the present disclosure.

FIG. 5 is an example of a visual representation of the image segmentation model-based content moderation process 500, in accordance with some embodiments of the present disclosure.

FIG. 6 is a flow diagram of an example method 600 of machine learning-assisted content moderation, in accordance with some embodiments of the present disclosure.

FIG. 7 is a block diagram of an example computer system 700 in which embodiments of the present disclosure can operate.

### DETAILED DESCRIPTION

Aspects of the present disclosure are directed to using trained machine learning models to assist with user reporting of multimedia content of an online system for content moderation. Examples of multimedia content include images, videos, links, text, files, and/or other digital media, which may be uploaded or otherwise provided to an online system for distribution to end users of the online system.

In prior content moderation approaches, end users of an online system manually report content items to the online system for content moderation. The online system engages one or more human moderators to review the end user reports and determine the outcomes for the end user-reported content items. While manual reviews and human moderation of content are common, the accuracy and consistency of manual-based content moderation decisions is challenging to maintain, especially when the human reviewers are presented with large amounts of user-reported content.

Multimedia content items can be especially challenging for human reviewers to evaluate. This is because it is not always immediately apparent to the human reviewer which portion or portions of the multimedia content item caused the end user to submit a report. For example, an image that contains a busy scene may need to be reviewed closely to determine which sub-item or sub-items of the image a user found objectionable.

When human reviewers are overwhelmed with large amounts of content to review, or when it is difficult or time consuming for the human reviewer to determine why a content item was reported, or when content moderation rules keep changing such that a human reviewer may not yet have the most up to date set of rules, the spread of harmful, malicious, or otherwise unsuitable content across the online system is difficult to control. As a result of the shortcomings of the prior content moderation approaches, content that is harmful, malicious, or otherwise unsuitable for distribution across the online system can proliferate before an effective moderation action can be taken, and, on the other hand, content which should be acceptable for distribution may be removed from the online system incorrectly.

Aspects of the present disclosure address the above and other deficiencies by using machine learning-assisted user reporting and moderation of content items, including multimedia content items. Machine learning models that are trained to classify different types of multimedia content, such as image segmentation models, text classifiers, and other models, are used to assist the end user doing the reporting and/or the human reviewer receiving the reported content, in identifying the particular sub-items of the multimedia content that need to be reported and reviewed.

The machine learning models are applied to sub-items of a multimedia content item submitted by an end user to a reporting system. Each model outputs a confidence score that indicates a probabilistic likelihood or statistical confidence that a particular sub-item of the multimedia content is associated with a particular label, such as a harmful or malicious content label, or another label identified with unsuitable content. Based on one or more of the confidence scores, the reporting system identifies one or more particular sub-items of the submitted content item that the reporting user can select and provide additional information to explain why the content item is being reported, or more specifically, what the user found objectionable about the selected sub-item of the submitted content item.

For example, a particular sub-item of an image (e.g., one particular person depicted in an image containing multiple people and objects) may be made selectable to the reporting user by the reporting system based on the machine learning model output. If the user selects the sub-item made selectable by the reporting system, the reporting system prompts the user for additional information about the selected sub-item. For instance, the reporting system prompts the user to select a label from a list of pre-defined labels and/or to add comments. As a result, the report generated by the machine learning-assisted reporting system contain more precise reporting information than the prior systems. The additional details provided by the machine learning-assisted reporting system can be very helpful in expediting the evaluation of the reported content item by the human reviewer and improve the accuracy of the human reviewer's evaluation of the reported content item, thereby improving the overall content moderation process in multiple ways.

This disclosure describes machine learning-assisted user reporting and moderation of multimedia content in an online system. However, the disclosed approaches have broader application. For example, the disclosed approaches are not limited to multimedia content items and are not limited to online systems. Also, the disclosed approaches can be used to moderate content on local systems and cloud systems. Additionally, the described approaches are not limited to uses within social media applications. Rather, the disclosed approaches can be employed to control and manage digital content in other types of application software systems including any type of system that performs digital content distribution.

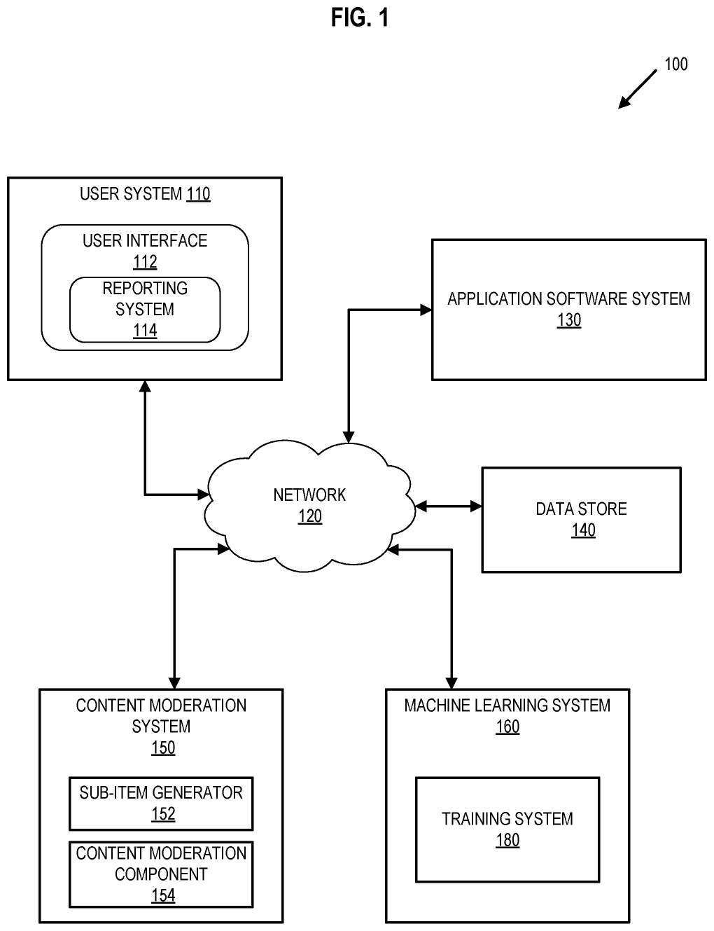

FIG. 1 illustrates an example computing system 100 that includes a content moderation system 150 in accordance with some embodiments of the present disclosure. In the embodiment of FIG. 1, computing system 100 includes a user system 110, a network 120, an application software system 130, a data store 140, content moderation system 150, and a machine learning model system 160.

As described in more detail below, content moderation system 150 includes a sub-item generator 152 and a content moderation component 154. Sub-item generator 152 generates sub-items of user-reported content items that have been reported through, e.g., a reporting system 114, and makes the sub-items user-selectable through the reporting system 114 at the reporting user's device. Content moderation component 154 uses information received about one or more of the sub-items from reporting system 114 to determine a content moderation outcome for the reported content item.

User system 110 includes at least one computing device, such as a personal computing device, a server, a mobile computing device, or a smart appliance. User system 110 includes at least one software application, including a user interface 112, installed on or accessible by a network to a computing device. User interface 112 includes a user interface of reporting system 114. User interface 112 or reporting system 114 can be or include a front-end portion of application software system 130 or content moderation system 150, for example.

User interface 112 is any type of user interface as described above. User interface 112 can be used to input search queries and view or otherwise perceive output that includes data produced by application software system 130 and/or content moderation system 150. For example, user interface 112 can include a graphical user interface, a virtual reality or mixed reality interface, and/or a conversational voice/speech interface that includes a mechanism for entering a search query, viewing and interacting with query results, news feed items, and/or other digital content.

Examples of user interface 112 include web browsers, command line interfaces, and mobile apps. User interface 112 as used herein can include application programming interfaces (APIs). In some embodiments, the user interface 112, or more specifically reporting system 114, includes graphical user interface control elements such as text input boxes and online forms, which enable an end user of user system 110 to generate electronic communications to identify and report harmful or malicious content to content moderation system 150. The user interface 112 or reporting system 114 can be configured to enable the reporting end user to select or identify a category or rule that the user believes is violated by a reported content item.

A typical user of user system 110 can be an administrator or end user of application software system 130, content moderation system 150, and/or machine learning system 160. User system 110 is configured to communicate bidirectionally with any of application software system 130, data store 140, content moderation system 150, and/or machine learning system 160 over network 120.

Network 120 can be implemented on any medium or mechanism that provides for the exchange of data, signals, and/or instructions between the various components of computing system 100. Examples of network 120 include, without limitation, a Local Area Network (LAN), a Wide Area Network (WAN), an Ethernet network or the Internet, or at least one terrestrial, satellite or wireless link, or a combination of any number of different networks and/or communication links.

Application software system 130 is any type of application software system that includes or utilizes functionality provided by content moderation system 150 and/or machine learning model system 160. Examples of application software system 130 include but are not limited to connections network software, such as social media platforms, and systems that are or are not based on connections network software, such as general-purpose search engines, job search software, recruiter search software, sales assistance software, advertising software, learning and education software, or any combination of any of the foregoing.

A client portion of application software system 130 can operate in user system 110, for example as a plugin or widget in a graphical user interface of a software application or as a web browser executing user interface 112. In an embodiment, a web browser can transmit an HTTP request over a network (e.g., the Internet) in response to user input that is received through a user interface provided by the web application and displayed through the web browser. A server running application software system 130 and/or a server portion of application software system 130 can receive the input, perform at least one operation using the input, and return output using an HTTP response that the web browser receives and processes.

Data store 140 is a memory storage. Data store 140 stores, for example, user data, application data, digital content items, digital content item submissions, content item sub-item data, such as bounding box coordinates and cropped images, content moderation reports, and/or moderation outcome data. Data store 140 can include one or more searchable data stores, such as databases implemented using relational, object-oriented, or graph database technologies, or key value stores, for example. Data store 140 can reside on at least one persistent and/or volatile storage device that can reside within the same local network as at least one other device of computing system 100 and/or in a network that is remote relative to at least one other device of computing system 100. Thus, although depicted as being included in computing system 100, portions of data store 140 can be part of computing system 100 or accessed by computing system 100 over a network, such as network 120.

Content moderation system 150 is configured to receive content item submissions, such as electronic communications and reported content items, from many user systems operated by end users of application software system 130, although only one user system 110 is shown in FIG. 1, and to provide moderation outcome data to the submitting users' systems in response to those submissions. In some embodiments, the application software system 130 includes at least a portion of the content moderation system 150. Sub-item generator 152 generates one or more sub-items for a content item submitted by a user through reporting system 114, and provides those sub-items to reporting system 114 for review by the submitting user. Content moderation component 154 generates content moderation outcome data for submitted content items based at least in part on user feedback on the sub-items generated by sub-item generator 152. The sub-item generator 152 and content moderation component 154 are each implemented using computer software, hardware, or a combination thereof.

In operation, content moderation system 150 receives an electronic communication from the user system that identifies one or more content items that are being submitted for content moderation review. In some embodiments, the content moderation system 150 receives communications identifying content items from the user systems 110 prior to the content items being distributed to other users of application software system 130. In other embodiments, the content moderation system 150 receives electronic communications from one or more user systems 110 after a content item has been distributed to at least one other end user and has been reported as harmful or malicious by at least one of the other end users of application software system 130.

In response to an electronic communication from a user system 110 that reports a content item for moderator review, the sub-item generator 152 of the content moderation system 150 determines a content type of at least one sub-item of the reported content item (e.g., text, image, or video of the content item), and requests a trained machine learning model from the machine learning model system 160 that is trained to classify items of that content type as needing moderator review or not needing moderator review. Using the requested trained machine learning model 160, the content moderation system 150 outputs a classification label for at least one sub-item of the submitted content item. For instance, a requested machine learning model identifies one or more regions of interest within a submitted content item as a sub-item, where a region of interest can include a segment of text, an image, a portion of an image, a frame of a video, or another type of content. The machine learning model classifies the identified region(s) of interest (e.g., sub-items) according to a classification scheme that labels content as needing moderator review or not needing moderator review, for example.

In an example, a submitted content item contains text and an image, and the sub-item generator 152 of content moderation system 150 identifies the image as a sub-item (or region of interest) within the submitted content item. The content moderation system 150 requests a trained image segmentation model from the machine learning model system 160 to process the identified sub-item using image segmentation to determine whether the sub-item contains content that is harmful or malicious.

In some implementations, the sub-item generator 152 sends information about each of the identified sub-items, such as its bounding box coordinates or on-screen x-y coordinates, to reporting system 114 along with a request for the reporting user to provide input regarding one or more of the identified sub-items. The reporting system 114 then displays each of the identified sub-items in a highlighted mode (e.g., by changing the background color or displaying the bounding box around each of the sub-items) and prompts the reporting user for input by, for example, making each of the sub-items user-selectable on the graphical user interface of reporting system 114. For example, the sub-item generator 152 sends a request to reporting system 114 for the user to select at least one of the user-selectable sub-items to identify the selected sub-item as the portion of the submitted content item that contains objectionable content. The reporting system 114 communicates user selections of selectable sub-items and any additional inputs to content moderation system 150.

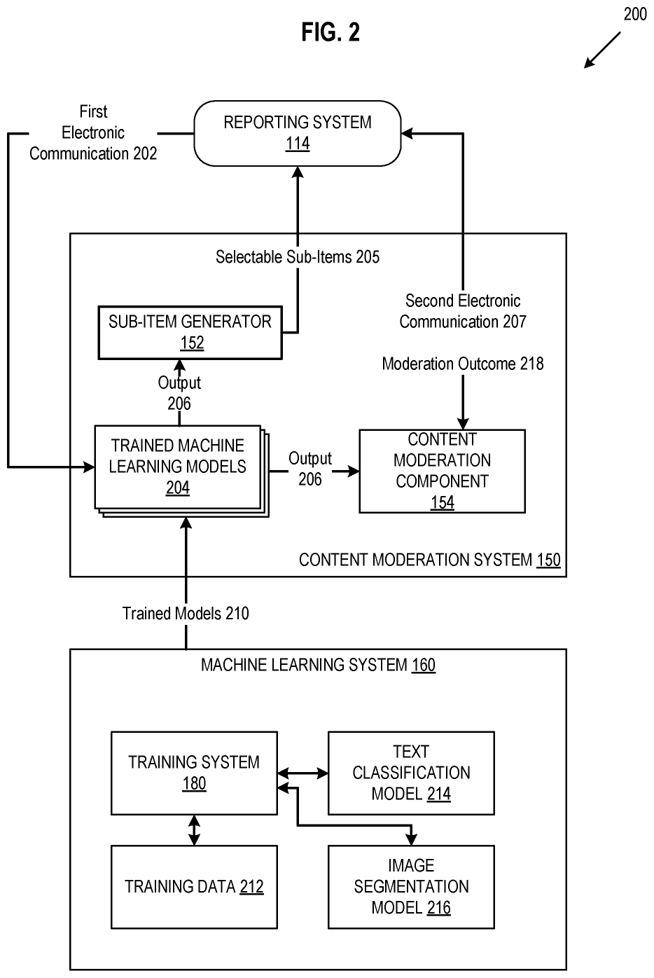

Content moderation component 154 receives output produced by the selected trained machine learning model (e.g., the trained image segmentation model) for each user-selected sub-item of the submitted content item. The machine learning model output includes a classification label and a value of a confidence metric associated with the classification label. Content moderation component 154 generates a moderation outcome for the submitted content item based on the machine learning model output, including the confidence value, produced for one or more of the sub-items. In some embodiments, the content moderation component 154 restricts or removes access to the content item or to at least the sub-item in response to determining that the associated confidence value is above a threshold confidence value. The threshold confidence value represents a level of certainty with which the machine learning-based classification of the content item or sub-item is accurate; for example, a statistical or probabilistic likelihood that the content item or sub-item matches other content that has been ground-truth determined to violate a rule, standard, or policy and should be removed from the online system. Additional details of the content moderation component 154 are discussed with reference to at least FIG. 2.

The machine learning system 160 stores and trains various machine learning models for use in performing machine learning-based content moderation as described. The machine learning system 160 receives requests from the content moderation system 150 to provide trained machine learning models for classifying content items and/or sub-items that have been identified by electronic communications received from reporting system 114.

The machine learning system 160 includes a training system 180. The training system 180 performs machine learning model training by, for example, applying a machine learning model to a curated set of training data. A curated set of training data includes, for instance, raw or computed features and ground-truth labels. In the context of content moderation, an instance of training data can include a content item or content item metadata and a ground truth label indicating a semantic characteristic or category to which the content item belongs, such as nudity, phishing, etc. The training system 180 uses training data to perform a supervised, semi-supervised, or unsupervised training as appropriate for each type of machine learning model.

Referring to the illustrative but non-limiting example above, the machine learning system 160 receives a request to process a sub-item of an image using a trained image segmentation model. The machine learning system 160 provides the functionality of the image segmentation model to the content moderation system 150 as described with reference to FIG. 2. Additional details regarding the machine learning system 160 are described with reference to FIGS. 2-5.

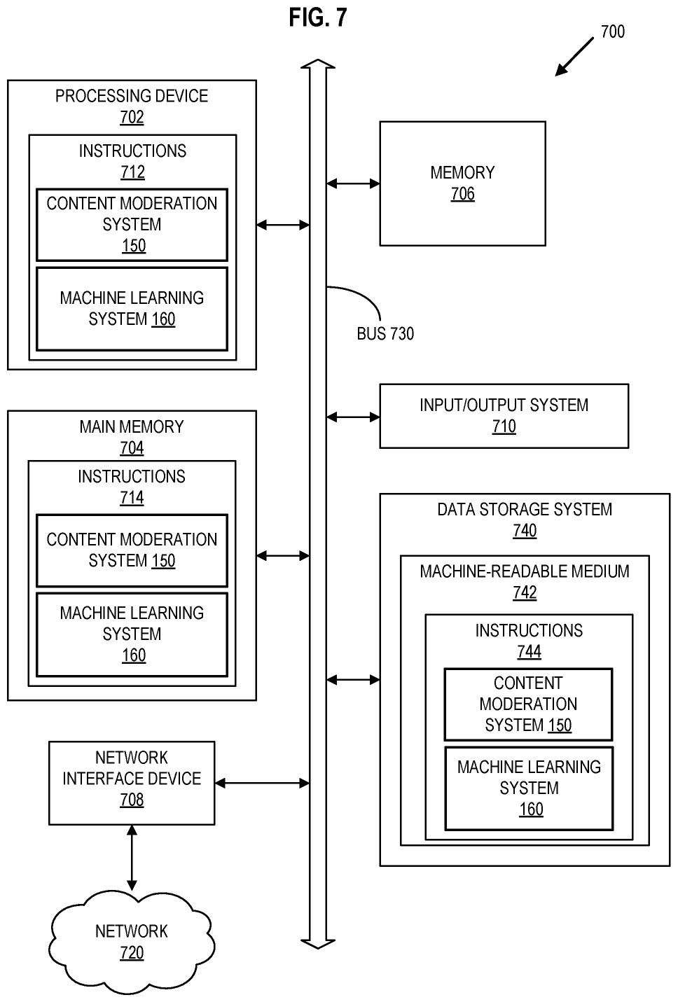

As shown in FIG. 7, the content moderation system 150 and the machine learning system 160 can each be implemented as instructions stored in a memory, and a processing device 702 can be configured to execute the instructions stored in the memory to perform the operations described herein.

The features and functionality of user system 110, application software system 130, data store 140, content moderation system 150, and machine learning system 160 are implemented using computer software, hardware, or software and hardware, and can include combinations of automated functionality, data structures, and digital data, which are represented schematically in the figures. User system 110, application software system 130, data store 140, content moderation system 150, and machine learning system 160 are shown as separate elements in FIG. 1 for case of discussion but the illustration is not meant to imply that separation of these elements is required. The illustrated systems, services, and data stores (or their functionality) can be divided over any number of physical systems, including a single physical computer system, and can communicate with each other in any appropriate manner.

While not specifically shown, it should be understood that any of user system 110, application software system 130, data store 140, content moderation system 150, and machine learning system 160 includes an interface embodied as computer programming code stored in computer memory that when executed causes a computing device to enable bidirectional communication with any other of user system 110, application software system 130, data store 140, content moderation system 150, and machine learning system 160 using a communicative coupling mechanism. Examples of communicative coupling mechanisms include network interfaces, inter-process communication (IPC) interfaces and APIs.

Each of user system 110, application software system 130, data store 140, content moderation system 150, and machine learning system 160 is implemented using at least one computing device that is communicatively coupled to electronic communications network 120. Any of user system 110, application software system 130, data store 140, content moderation system 150, and machine learning system 160 can be bidirectionally communicatively coupled by network 120. User system 110 as well as one or more different user systems (not shown) can be bidirectionally communicatively coupled to application software system 130.

As illustrated in FIG. 1, the machine learning system 160 includes a training system 180. The training system 180 can be responsible for training each machine learning model based on a type of content to be classified. In some embodiments, the training system 180 trains neural networks, classifiers, or other machine learning models using supervise, semi-supervised, or unsupervised training appropriate for each machine learning model.

FIG. 2 is a flow diagram of an example method 200 to select machine learning models and perform content moderation using content sub-items, in accordance with some embodiments of the present disclosure. In some embodiments, the user interface executed on the user system 110, such as described above with regard to FIG. 1, communicates an electronic communication to the content moderation system 150, such as a user-generated request for moderator review of a content item. As described above with reference to FIG. 1, the electronic communication can include a content item that is being submitted by a user or identify a content item that has been submitted and distributed to at least one other end user. As described with regard to FIG. 1, the content moderation system 150 generates a moderation outcome 218 for the content item included or identified in a first electronic communication 202. The content moderation system 150 requests at least one trained machine model from the machine learning system 160 to identify and classify one or more sub-items of the content item.

In an example, the content moderation system 150 analyzes the first electronic communication 202 and determines that the first electronic communication 202 identifies at least one text region associated with a user profile and an image associated with the user profile (e.g., a text feed, public messages, private messaging, group descriptions, etc.), where the user profile, text feed, messages, group description, or images have been previously uploaded and distributed by the online system. The sub-item generator 152 of content moderation system 150 identifies the region of text as a sub-item of the content item and identifies the image as another sub-item of the content item.

A first machine learning model of the trained machine learning models 204, e.g., a text classifier, classifies the text sub-item as either needing moderator review or not needing moderator review. For instance, a sub-item may need moderator review if the machine learning model output 206 indicates that the sub-item has a high likelihood of containing harmful or malicious content.

To process the text sub-item, the content moderation system 150 accesses a text classification model of the trained machine learning models 204 and applies the text classification model to the text sub-item. The text classification model processes the region of text to determine if the region of text includes content that is harmful or malicious. In some embodiments, the text classification model is trained to detect phishing links or solicitations for unlawful actions. The text classification model generates an output 206 that represents a confidence value that the region of text includes harmful content. The output 206 can indicate, for example, a classification such as phishing, solicitation, and a confidence value between [0, 1] indicating a mathematical likelihood that the region of text sub-item includes text falling within the classification.

A second machine learning model of the trained machine learning models 204, e.g., an image classifier, classifies the image sub-item as either needing moderator review or not needing moderator review. For example, an image segmentation model generates an output 206 that represents a confidence value that indicates a mathematical likelihood that the image includes harmful content. The output 206 can indicate a classification such as nudity, logos, or body gestures, and the confidence value may be a value between [0, 1] indicating the likelihood that the image sub-item includes an object in the classification.

The individual or collective machine learning model outputs 206 are provided to sub-item generator 152 and to content moderation component 154. Based on the machine learning model outputs 206, sub-item generator 152 generates selectable sub-items 205 and provides the selectable sub-items 205 to reporting system 114. For instance, if the machine learning model output indicates that the text sub-item includes a phishing solicitation, sub-item generator 152 sends instructions to reporting system 114 to highlight the text sub-item and render the highlighted text sub-item user-selectable.

Similarly, if the machine learning model output indicates that the image sub-item includes nudity or obscenity, sub-item generator 152 sends instructions to reporting system 114 to display a bounding box around the image sub-item and render the image content within the bounding box user-selectable. In response to the reporting system 114 rendering the selectable sub-items 205, the reporting system 114 receives user input on one or more of the selectable sub-items 205 and sends that user input to content moderation component 154 in one or more second electronic communications 207.

Stated another way, sub-item generator 152 receives the output 206 from the trained machine learning models 204 and generates a request for a second electronic communication 207. The request includes selectable sub-items 205 that correspond to sub-items in the output 206. In some embodiments, the sub-item generator 152 requests a selection from the user, using the reporting system 114, of at least one of the selectable sub-items 205 as the harmful content. Using the selection of the user, the reporting system 114 generates the second electronic communication 207 including the user selections of the selectable sub-items 205.

The content moderation component 154 generates moderation outcome 218 in response to the machine learning model outputs 206 and information contained in one or more second electronic communications 207 received from reporting system 114. In the example above, the content moderation component 154 receives two machine learning outputs 206 (e.g., machine learning outputs from each of the image segmentation model and the text classification model). The moderation outcome 218 generated by content moderation component 154 can include one or more moderation outcomes. For example, the content moderation component 154 can generate a moderation outcome only for one sub-item for which the machine learning model output has a high confidence score. For instance, if a machine learning model classifies the image sub-item as containing nudity with high confidence but another machine learning model classifies the text sub-item as containing phishing with low confidence, only the machine learning model output for the image sub-item may be included in the moderation outcome 218 while the machine learning model output for the text sub-item is not included in the moderation outcome 218. Based on or as part of moderation outcome 218, content moderation component 154 can provide instructions to reporting system 114 to remove access to only the image sub-item, to both sub-items, or to neither of the sub-items. In other examples, the content moderation component 154 can remove access to the entire content item containing the sub-items (e.g., a user profile associated with the text sub-item and/or the image sub-item).

Content moderation component 154 is in bidirectional communication with reporting system 114. For example, content moderation component 154 receives second electronic communications 207 from reporting system 114, and content moderation component 154 sends moderation outcomes 218 to reporting system 114.

In some embodiments, if the output 206 is greater than a threshold confidence value (e.g., 0.75 on a scale of 0 to 1), the content moderation component 154 removes access to a content item or sub-item from user system 110. Returning to the previous example, for some electronic communications, more than one output 206 are generated (such as one output per trained machine learning model). In some examples, the content moderation component 154 determines a moderation outcome 218 using a highest value of the machine learning outputs 206, or performs an average of all of the values of the machine learning outputs 206, or applies a weighted average with each type of content (e.g., image, text) having a weight that represents a relative importance of the type of content. For instance, an image that includes harmful or malicious content is assigned a higher weight value than text that includes harmful or malicious content. In some examples, the content moderation component 154 determines the moderation outcome 218 using both of the machine learning outputs 206 and applies a moderation outcome 218 to both the text region sub-item and the image sub-item.

The content moderation component 154 outputs moderation outcome 218 to the user system 110 based on the output 206. In some embodiments, the moderation outcome 218 is a notification that represents a moderation action that is applied to the content item or sub-item. For example, moderation outcome 218 can include an indication of the (1) removal of access to the content item or sub-item, (2) a determination that the content item or sub-item is authorized and does not contain harmful content, or (3) an escalation of review has been requested and the content has been flagged as potentially harmful or malicious.

In the example of FIG. 2, training system 180 performs machine learning model training to generate a trained text classification model 214 and a trained image segmentation model 216. While two models are illustrated in FIG. 2, the machine learning system 160 can contain any number of machine learning models and training system 180 can train any number of models. To train a model, training system 180 applies a machine learning algorithm to training data 212 using, for example, supervised, semi-supervised, or unsupervised training as appropriate for each type of machine learning model. In the example illustrated by FIG. 2, the training data 212 used to train the text classification model 214 includes training examples of text regions labeled with text indicating whether the training example is a positive or negative example (e.g., includes or does not include harmful or malicious content). To train the image segmentation model 216, the training data 212 used by the training system 180 includes training examples of images or image regions (e.g., bounding boxes) labeled with text indicating whether the training example is a positive or negative example (e.g., includes or does not include harmful or malicious content).

In response to a request for a machine learning model from the content moderation system 150, the machine learning system 160 provides one or more trained models 210 for use as trained machine learning models 204.

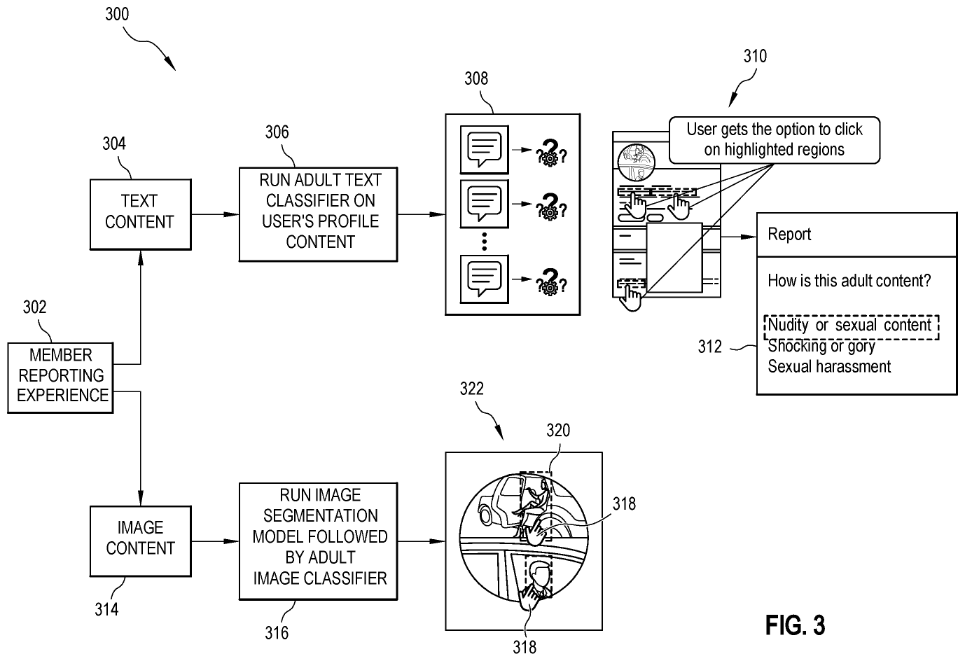

In some implementations, the content moderation component 154 receives the output of a selected machine learning model (e.g., the trained image segmentation model) and selects a moderation outcome based on the confidence value associated with the output of the machine learning model. In some embodiments, the content moderation component 154 restricts or removes access to the content item or sub-item in response to determining that the confidence value is above a threshold confidence value. The threshold confidence value represents a degree of certainty that the content item or sub-item is harmful or malicious and should be removed from the online system. Additional details of the content moderation component 154 are discussed with reference to at least FIGS. 3-5.

FIG. 3 is an example of a machine learning-assisted content moderation process 300, in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the content moderation system 150 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel such as operations 304 and 314. Additionally, one or more processes can be omitted in various embodiments. Thus, not all processes are required in every embodiment. Other process flows are possible.

At operation 302, the content moderation system 150 receives an electronic communication from a user system 110 using reporting system 114. As described above, a first electronic communication can include a content item that is being submitted by a user or identify a content item or sub-item that has been submitted and distributed to at least one other end user. The content moderation system 150 determines if a content item includes any sub-items, such as a text region or image content. To determine whether a content item includes text and/or image sub-items, in some implementations, the content moderation system 150 reads the file extensions of the sub-items. For example, if a content item contains a file with the extension .txt or .doc, for example, the content moderation system 150 determines that the file contains a text sub-item and sends the text sub-item to the text classification model 214. Similarly, if a content item contains a file with the extension .pdf or .jpg, for example, the content moderation system 150 determines that the file contains an image sub-item and sends the image sub-item to the image classification model 216.

To process a text sub-item, the content moderation system 150 requests access to a text classification model from the trained machine learning models and proceeds to operation 304. To process an image sub-item, the content moderation system 150 requests access to an image segmentation model from the trained machine learning models and proceeds to operation 314.

At operation 304, the content moderation system 150 requests access to the text classification model of the trained machine learning models 204 and applies the text classification model to the text sub-item identified by the first electronic communication 202. The text classification model processes the text sub-item to determine if the text sub-item includes content that is harmful or malicious.

At operation 306, the content moderation system 150 applies the text classification model to the text sub-item. In some embodiments, the text classification model processes the text sub-item to determine if any region of text within the text sub-item includes content that is harmful or malicious. To identify subjects or words, the text classification model is trained to extract features from a region of text using a training set of words that identify harmful or malicious content. After training, the text classification model can identify subjects or words within the region of text sub-item that are similar to harmful or malicious content. For example, the text classification model tokenizes the region of text and searches an embedding space that includes other tokens to identify similar words or subjects. A linear difference between each token of the region of text and other tokens in the embedding space is computed and the text classification model determines if the tokens of the region of text represent harmful or malicious content.

In other embodiments, the text classification model performs semantic analysis using a training set of documents that represent malicious and/or harmful topics. Using the training set of documents, the text classification model is trained to identify meanings of words in the region of text that are similar to the harmful topics of the training set of documents. Examples of semantic analysis include latent semantic analysis by representing the terms of the region of text in a vector space of topics. Other semantic analysis such as generating a knowledge graph or term frequency-inverse document frequency can be performed. In still other embodiments, the text classification model is trained to detect phishing links that are selectable by the user (e.g., a link in the text associated with a user profile, a feed, a post, or a message). The text classification model generates a machine learning output which indicates a classification and the confidence value that the region of text sub-item includes text falls within the classification.

At operation 308, the content moderation component 154 receives the output of the text classification model. In some embodiments, the content moderation component 154 compares the confidence value to a threshold confidence value or a set of threshold confidence values. In some implementations, the threshold confidence value or set of threshold confidence values are pre-determined for each type of content, where the content type could be violence or nudity, for example, as described above. For instance, content identified as violent could have a lower threshold confidence (e.g., a lower requirement to remove) than content identified as nudity. The particular threshold confidence values are determined based on the requirements or design of the particular implementation.

In some implementations, the confidence value is compared to the set of threshold confidence values to select a moderation outcome. For example, the content moderation component 154 can select a first moderation outcome for a threshold confidence value between [0.75, 1], a second moderation outcome for a threshold confidence value between [0.5, 0.74], or a third moderation outcome for a threshold confidence value between [0, 0.49]. In some implementations, the first moderation outcome includes removal of access or deletion of the content sub-item, the second moderation outcome includes determining that the content sub-item is authorized, and the third moderation outcome includes an escalation for additional review. In some embodiments, the content moderation component 154 can also determine if a request for additional information improves the confidence score. For example, for certain scores (e.g., 0.45-0.55) that are within a distance of the threshold confidence value, the content moderation component 154 determines that a request for additional information will adjust the confidence score to a higher value. The request for additional information is described below with reference to operations 310 and 312.

At operation 310, the sub-item generator 152 requests additional information from the user by providing a set of selectable sub-items to the reporting system 114. In some embodiments, the sub-item generator 152 requests a category for the region of text sub-items from the user system. As part of requesting additional information, at operation 310A, the sub-item generator 152 provides (e.g., with the request for additional information) a suggested set of categories that correspond to the machine learning output for each selectable sub-item. In some embodiments, the set of suggested categories can include one or more of the classifications output by the text classification model. At operation 312, the content moderation component 154 can compare the response (e.g., the second electronic communication 207 as described above) from the reporting system to the request for additional information. For example, the content moderation component 154 compares the category received from the user system and select the moderation outcome 218 as described above. If the content moderation system 150 determines that the category received matches one of the classifications of the selectable sub-items, the content moderation component 154 can increase the confidence score and select a moderation outcome.

Returning to operation 302, to process the image sub-item, the content moderation system 150 requests access to an image segmentation model from the trained machine learning models and proceeds to operation 314. At operation 314, the content moderation system 150 accesses an image segmentation model of the trained machine learning models to classify the image sub-item identified by the electronic communication. The image segmentation model processes the image to determine if the image includes content that is harmful or malicious. In some embodiments, the image segmentation model identifies objects by classifying objects using training that is performed using a set of training images and object labels. The image segmentation model outputs a set of objects and corresponding confidence values that an object is identified accurately. Each object is identified by bounding box data. Bounding box data includes, for example, two- or three-dimensional coordinates that identify the outer boundaries of the portion of the image that contains the identified object. After identifying objects, the output of the image segmentation model is used to compare the identified objects to a set of harmful or malicious images at operation 316.

At operation 316, the output of the image segmentation model includes a value that represents a comparison of the identified objects to a set of harmful or malicious objects. For example, the set of harmful or malicious objects is pre-defined (e.g., by a set of training data) in some implementations, and the output of the image segmentation model includes a similarity score that indicates how similar an identified object is to one or more objects contained in the set of harmful or malicious objects.

The content moderation component 154 receives the output of the image segmentation model 216. In some embodiments, the content moderation component 154 compares each object and corresponding confidence value to a set of harmful objects that each have a corresponding threshold confidence value. For instance, a first confidence value associated with a violent object (e.g., a weapon) can be different than a second confidence value associated with an overexposed human (e.g., nudity). The content moderation component 154 selects a moderation outcome using the threshold confidence value associated with the object identified by the image segmentation model and a set of harmful objects. The content moderation component 154 can select a moderation outcome that includes removal of access or deletion of the content sub-item, determining that the content sub-item is authorized, or an escalation for additional review. In some embodiments, the content moderation component 154 can also determine if a request for additional information improves the confidence score or identification of the object from the image segmentation model. For example, for certain scores that are within a distance of the threshold confidence value for the identified object, the sub-item generator 152 requests additional information from the user system. The request for additional information is described below with reference to operation 320.

At operation 320, the sub-item generator 152 requests additional information from the user system. In some embodiments, the sub-item generator 152 provides at least one bounding box (e.g., a sub-item) that includes an identified object. The sub-item generator 152 requests 152 requests the user system to identify the object of the electronic communication that is identified as harmful or malicious. As illustrated by FIG. 3, selectable sub-items include the bounding boxes 320A and 320B and are provided to the user system with bounding box 320A including an overexposed human (e.g., nudity) and bounding box 320B including a person but not a harmful object. If the content moderation component 154 receives a response to the request for additional information, the content moderation component 154 can generate an adjusted classification or an adjusted confidence score based on a combination of the output of the machine learning model and the response to the request for additional information.

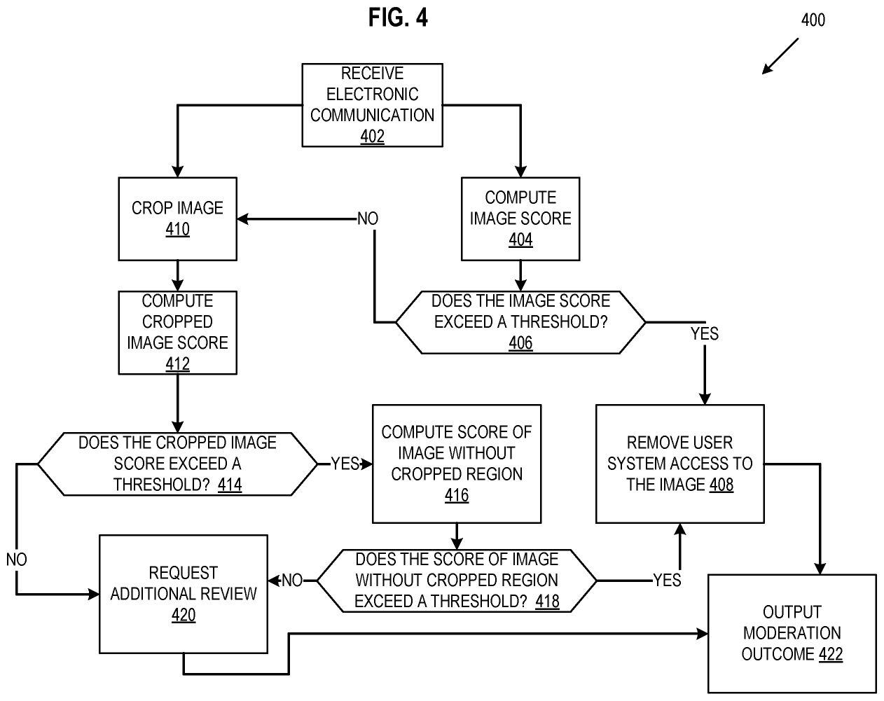

FIG. 4 is an example of an image segmentation model-based content moderation process, in accordance with some embodiments of the present disclosure. The process 400 performs by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the process 400 is performed by the content moderation system 150 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 402, the content moderation system 150 receives an electronic communication. As described above, the content moderation system 150 receives an electronic communication from the user system that identifies content item(s) as harmful or malicious by at least one of the other end users.

At operation 404, the content moderation system 150 computes an image score. As described above with reference to FIG. 3, the image segmentation model 216 generates an output that represents identified objects that are potentially harmful or malicious objects. In some implementations, image segmentation model 216 generates, for a given identified object, a separate score for each category of ground-truth harmful or malicious objects, and aggregates the individual category scores to produce a composite score for the image that identifies a total likelihood of the image including a harmful or malicious object (e.g., an aggregate of the confidence scores for each object that is potentially harmful). The aggregation function used is determined by the requirements of a particular design or implementation, and could include a sum, average, mean, or median, for example. For example, if an identified object has a violent score of 0.9 on a scale of 0 to 1, and the same identified object has a nudity score of 0.7 on the same scale of 0 to 1, the aggregate score for that identified object could be 0.8, which is the average of the two individual scores.

At operation 406, the content moderation system 150 compares the image score to a threshold image score. The content moderation system 150 receives the aggregate of the confidence scores for each object that is potentially harmful. In some embodiments, the content moderation component 154 compares the aggregate of the confidence scores to an aggregate threshold score. In response to determining that the aggregate of the confidence scores is greater than the aggregate threshold score, the content moderation component 154 can select moderation outcome that includes removal of access or deletion of the content sub-item by proceeding to operation 408. In response to determining that the aggregate of the confidence scores is less than the aggregate threshold score, the process proceeds to operation 410.

At operation 408, the content moderation component 154 removes user system access to the image identified by the electronic communication. As described above, the removal can include denying access, deleting the image file, or restricting distribution of the image by the online system.

At operation 410, the content moderation system 150 can crop the image to a bounding box that contains an object identified by the image segmentation model as potentially harmful. For example, an image segmentation model identifies the bounding box coordinates of an object and extracts only the portion of the image contained within the identified bounding box as the cropped image. In some embodiments, the content moderation system 150 crops the image received in the electronic communication to a bounding box that includes the overexposed human. The content moderation system 150 can crop the image in multiple different ways to create regions of interest or sub-items, where each region of interest or sub-item corresponds to an identified object. After cropping the image, the process proceeds to operation 412 to compute a cropped image score.

At operation 412, the image segmentation model computes a score of the cropped image (e.g., the bounding box for each object that is potentially harmful). The score for the cropped image is computed similarly to the operations at operation 404 for computing an image score, but only includes portions of the image that are within the cropped image.

At operation 414, the content moderation system 150 compares the cropped image score to a cropped threshold score. In some embodiments, the content moderation component 154 compares a confidence value of the identified object in the cropped image (e.g., from the image segmentation model) with a threshold value for the object (e.g., a cropped threshold score which represents a threshold for the object alone). In response to determining that the cropped image score exceeds the cropped threshold score, the process proceeds to operation 416. Alternatively, in response to determining that the cropped image score is less than the cropped threshold score, the process proceeds to operation 4420.

At operation 416, the content moderation system 150 uses the image segmentation model to compute an image score as described above with reference to operation 404, with the bounding box of the cropped image removed from the image (e.g., the potentially harmful object is removed).

At operation 418, the content moderation system 150 compares the image without the cropped image to the image threshold score. The content moderation system 150 receives the aggregate of the confidence scores for the image with the cropped bounding box removed. In some embodiments, the content moderation component 154 compares the aggregate of the confidence scores to an aggregate threshold score. In response to determining that the aggregate of the confidence scores is greater than the aggregate threshold score, the content moderation component 154 can select moderation outcome that includes removal of access or deletion of the content sub-item by proceeding to operation 408. In response to determining that the aggregate of the confidence scores is less than the aggregate threshold score, the process proceeds to operation 420.

At operation 420, the content moderation system 150 requests an escalation for moderation such as assigning the image from the first electronic communication 202 to a queue of a moderation process. The content moderation system 150 receives the output from the moderation process and selects the moderation outcome identified by the moderation process. After applying the moderation outcome, the process proceeds to operation 410.

At operation 422, the content moderation component 154 outputs the moderation outcome to the user system. In some embodiments, the content moderation component 154 generates a notification to the user system that identifies the moderation outcome selected, the classification of the image, and an identification of first electronic communication 202.

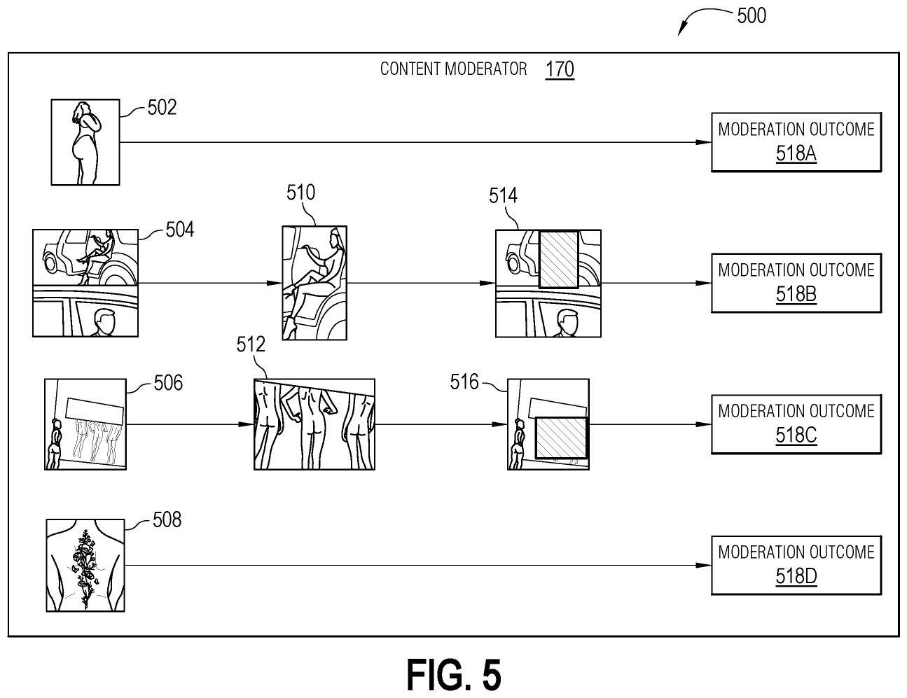

FIG. 5 is an example of a perceptual representation of the image segmentation model-based content moderation process, in accordance with some embodiments of the present disclosure. As illustrated by FIG. 5, images 502, 504, 506, and 508 are received by the content moderation system 150. The images are processed by the content moderation system 150 using the image segmentation model as described above with reference to FIGS. 3-4.

As described above with reference to FIG. 4, the content moderation system 150 determines that the image score for the image 502 exceeds the threshold confidence value and is processed using a first moderation outcome 518A that represents removal of access to the image. As further described with reference to FIG. 4, the images 504 and 506 are processed using a cropped image score of cropped regions 510 and 512, respectively. The images 504 are also processed to compute an image score that excludes the cropped region as illustrated by adjusted images 514 and 516, respectively. The image 504 is processed using a second moderation outcome 518B that represents a removal of access to the image. As described above with reference to FIG. 4, the image 508 is processed using a third moderation outcome 518C that represents a request for escalation to a moderation process. As described above, the image 508 is determined as authorized and to not include harmful objects and is processed using a fourth moderation outcome 518D that does not restrict access to the image.

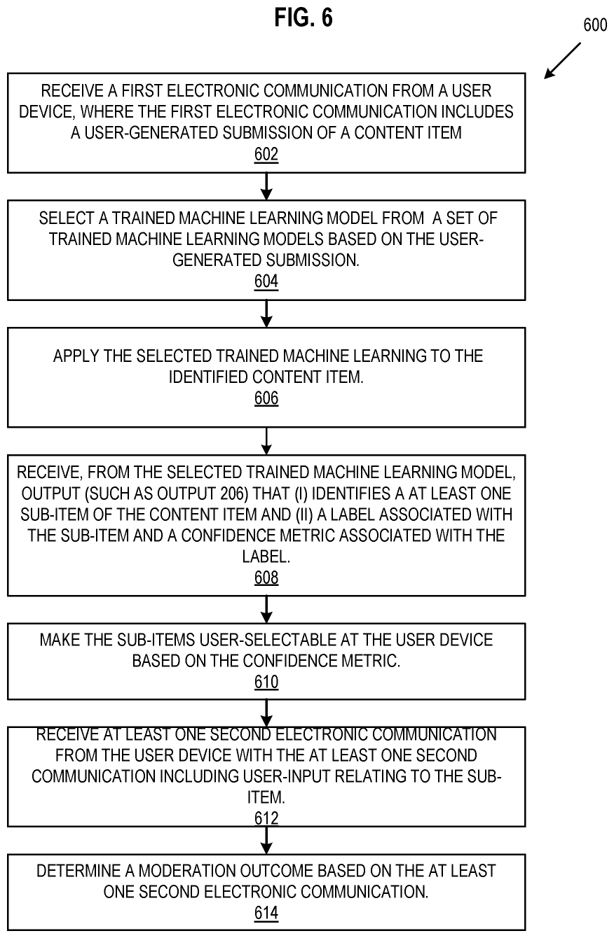

FIG. 6 is a flow diagram of an example method 600 of machine learning-based content moderation, in accordance with some embodiments of the present disclosure. The method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 600 is performed by the content moderation system 150 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 602, the content moderation system 150 receives a first electronic communication from a user device that includes a user-generated submission of a content item for content moderation. For example, the content moderation system 150 receives an end user generated report that selects a content item as potentially harmful or malicious. As described above, the end user submits a request for content moderation for a content item that has previously been submitted and distributed by the online system using a reporting system 114 of user system 110. As further described above, the end user submits a request for content moderation for a content item that is being submitted for distribution by the online system using a reporting system 114 of user system 110.

At operation 604, the content moderation system 150 selects a trained machine learning model from a plurality of trained machine learning models based on the user-generated submission. As described above, the content moderation system 150 selects a trained model such as an image segmentation model or a text classification model using a type of the content item and the request to apply a moderation outcome to the content as received above at operation 602. In some embodiments, the content moderation system 150 selects the trained machine learning model using the type of content identified by the user in the report for a profile text, an image, or a combination thereof. In other implementations, the content moderation system 150 determines the content type by reading the file extension data (e.g., .jpg or .doc, as described above. The content moderation system 150 selects the text classification, image segmentation, or both.

At operation 606, the content moderation system 150 applies the selected trained machine learning model to the identified content item. For example, the content moderation system 150 applies a text classification model to a region of text in the content item. The trained machine learning model that is selected at operation 604 is used to generate a machine learning output that represents a confidence value that the content item includes harmful or malicious content. As described above, the machine learning output can be a combination of more than one machine learning model that are each applied to different content items identified by the first electronic communication.

At operation 608, the content moderation system 150 receives, from the selected trained machine learning model, output (such as output 206) that (I) identifies a at least one sub-item of the content item and (II) a label associated with the sub-item and a confidence metric associated with the label. As described above, the output 206 identifies a sub-item with a label such as an over exposed person, a logo representing violence, an offensive body gesture, or other sub-items. The machine learning model assigns a confidence value to each sub-item identified.

At operation 610, the sub-item generator 152 makes the sub-items user-selectable at the user device based on the confidence metric. As described above, the sub-item generator 152 generates a request for a second electronic communication with the request including selectable sub-items identifying each sub-item of the output from the machine learning model.

At operation 612, the content moderation component 154 receives at least one second electronic communication from the user device with the at least one second communication including user-input relating to the sub-item. In some embodiments, in response to the sub-item generator 152 requesting the user select at least one of the selectable sub-items as the harmful content at operation 610. Using the selection of the user, the user device generates the at least one second electronic communication. The content moderation component 154 receives the at least one second electronic communication as described above.

At operation 614, the content moderation component 154 provides the at least one second electronic communication and the sub-item to a content moderation process. As described above with reference to at least FIG. 2, the content moderation component 154 applies a moderation outcome to the sub-item and/or the content item. As further described above, the content moderation component 154 removes or restricts access to the content item or sub-item. In some embodiments, the moderation outcome is provided to the user that initiated the user-generated submission in a notification that represents a moderation action that is applied to the content item or sub-item. In other embodiments, the moderation outcome initiates an escalation for additional review as described above with reference to FIG. 4.

FIG. 7 illustrates an example machine of a computer system 700 within which a set of instructions, for causing the machine to perform any one or more of the methodologies discussed herein, can be executed. In some embodiments, the computer system 700 can correspond to a component of a networked computer system (e.g., the computer system 100 of FIG. 1) that includes, is coupled to, or utilizes a machine to execute an operating system to perform operations corresponding to the content moderation system 150 of FIG. 1. The machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a smart phone, a tablet PC, a set-top box (STB), a Personal Digital Assistant (PDA), a cellular telephone, a web appliance, a server, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random-access memory (DRAM) such as synchronous DRAM (SDRAM) or Rambus DRAM (RDRAM), etc.), a memory 706 (e.g., flash memory, static random access memory (SRAM), etc.), an input/output system 710, and a data storage system 740, which communicate with each other via a bus 730.

Processing device 702 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 can also be one or more special-purpose processing devices such as an application specific integrated circuit (ASIC), a field programmable gate array (FPGA), a digital signal processor (DSP), network processor, or the like. The processing device 702 is configured to execute instructions 712 for performing the operations and steps discussed herein.

The computer system 700 can further include a network interface device 708 to communicate over the network 720. Network interface device 708 can provide a two-way data communication coupling to a network. For example, network interface device 708 can be an integrated-services digital network (ISDN) card, cable modem, satellite modem, or a modem to provide a data communication connection to a corresponding type of telephone line. As another example, network interface device 708 can be a local area network (LAN) card to provide a data communication connection to a compatible LAN. Wireless links can also be implemented. In any such implementation network interface device 708 can send and receive electrical, electromagnetic or optical signals that carry digital data streams representing various types of information.

The network link can provide data communication through at least one network to other data devices. For example, a network link can provide a connection to the world-wide packet data communication network commonly referred to as the “Internet,” for example through a local network to a host computer or to data equipment operated by an Internet Service Provider (ISP). Local networks and the Internet use electrical, electromagnetic or optical signals that carry digital data to and from computer system to computer system 700.

Computer system 700 can send messages and receive data, including program code, through the network(s) and network interface device 708. In the Internet example, a server can transmit a requested code for an application program through the Internet and network interface device 708. The received code can be executed by processing device 702 as it is received, and/or stored in data storage system 740, or other non-volatile storage for later execution.

The input/output system 710 can include an output device, such as a display. Examples are, but not limited to a liquid crystal display (LCD) or a touchscreen display, for displaying information to a computer user, or a speaker, a haptic device, or another form of output device. The input/output system 710 can include an input device, for example, alphanumeric keys and other keys configured for communicating information and command selections to a processing device 702. An input device can, alternatively or in addition, include a cursor control, such as a mouse, a trackball, or cursor direction keys for communicating direction information and command selections to a processing device 702 and for controlling cursor movement on a display. An input device can, alternatively or in addition, include a microphone, a sensor, or an array of sensors, for communicating sensed information to a processing device 702. Sensed information can include voice commands, audio signals, geographic location information, and/or digital imagery, for example.

The data storage system 740 can include a machine-readable storage medium 742 (also known as a computer-readable medium) on which is stored one or more sets of instructions 744 or software embodying any one or more of the methodologies or functions described herein. The instructions 744 can also reside, completely or at least partially, within the main memory 704 and/or within the processing device 702 during execution thereof by the computer system 700, the main memory 704 and the processing device 702 also constituting machine-readable storage media.

In one embodiment, the instructions 744 include instructions to implement functionality corresponding to a content moderation system (e.g., the content moderation system 150 of FIG. 1). While the machine-readable storage medium 742 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the computing system 100, can carry out the computer-implemented method 500 in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

Illustrative examples of the technologies disclosed herein are provided below. An embodiment of the technologies may include any of the examples or a combination of the described below.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
receiving a first electronic communication from a user device, the first electronic communication comprising a user-generated submission of a content item;
selecting a trained machine learning model from a plurality of trained machine learning models based on the user-generated submission;
applying the selected trained machine learning model to the content item;
receiving, from the selected trained machine learning model, output that (i) identifies at least one sub-item of the content item and (ii) comprises, for a sub-item, a label associated with the sub-item and a confidence metric associated with the label;
based on the confidence metric, making the sub-item user-selectable at the user device;
receiving at least one second electronic communication from the user device, the at least one second electronic communication comprising user input relating to the sub-item; and
determining a moderation outcome based on the at least one second electronic communication.

2. The method of claim 1, wherein the content item comprises at least one of text, image, video, or multimodal content that is extracted from at least one of a user profile, a feed, a post, or a message.

3. The method of claim 2, wherein selecting the trained machine learning model from the plurality of trained machine learning models comprises at least one of:
selecting a text classification model for the text; or
selecting an image segmentation model for the image.

4. The method of claim 2, wherein applying the selected trained machine learning model to the content item comprises generating a classification of the content item and a confidence score associated with the classification.

5. The method of claim 4, wherein generating a classification of the content item and a confidence score associated with the classification comprises:
cropping the image to a region of interest within the image; and
computing a classification and a confidence score for the region of interest.

6. The method of claim 1, further comprising at least one of:
removing an access of the user device to the sub-item; or
sending a notification to the user device.

7. The method of claim 1, further comprising at least one of:
restricting an access of the user device to the sub-item; or
generating an escalation of review.

8. The method of claim 1, further comprising generating a request for additional information about the sub-item from the user device, wherein the request for additional information comprises a prompt for the at least one second electronic communication.

9. The method of claim 8, wherein the prompt for the at least one second electronic communication includes a set of selectable sub-items, the prompt further comprising:
requesting a user selection of at least one selectable sub-item of the set of selectable sub-items; and
comparing the user selection of at least one selectable sub-item with the label associated with the sub-item and a confidence metric associated with the label.

10. The method of claim 9, wherein the at least one selectable sub-item includes a portion of text or an object depicted in an image.

11. A system comprising:
at least one memory device; and
a processing device, operatively coupled to the at least one memory device, to:
receive a first electronic communication from a user device, the first electronic communication comprising a user-generated submission of a content item;
select a trained machine learning model from a plurality of trained machine learning models based on the user-generated submission;
apply the selected trained machine learning model to the content item;
receive, from the selected trained machine learning model, output that (i) identifies at least one sub-item of the content item and (ii) comprises, for a sub-item, a label associated with the sub-item and a confidence metric associated with the label;
based on the confidence metric, make the sub-item user-selectable at the user device;
receive at least one second electronic communication from the user device, the at least one second electronic communication comprising user input relating to the sub-item; and
determining a moderation outcome based on the at least one second electronic communication.

12. The system of claim 11, wherein the content item comprises at least one of text, image, video, or multimodal content that is extracted from at least one of a user profile, a feed, a post, or a message.

13. The system of claim 12, wherein to select a trained machine learning model from a plurality of trained machine learning models based on the content item and the first electronic communication causes the processing device further to:
select a text classification model for text; and
selecting an image segmentation model for the image.

14. The system of claim 12, wherein to apply the selected trained machine learning model to the identified sub-item causes the processing device further to generate a classification of the content item and a confidence score associated with the classification.

15. The system of claim 14, wherein to generate a classification of the content item and a confidence score associated with the classification causes the processing device further to:
cropping the image to a region of interest within the image; and
computing a classification and confidence score for the region of interest.

16. The system of claim 11, wherein the processing device is operatively coupled to the at least one memory device further to:
remove an access of the user device to the at least one sub-item; and
generate a notification to the user device indicating that the access has been removed.

17. The system of claim 11 the processing device further caused to generate a request for additional information about the sub-item from the user device, wherein the request for additional information comprises a prompt for the at least one second electronic communication.

18. The system of claim 17, wherein the prompt for the at least one second electronic communication includes a set of selectable sub-items, the prompt causes the processing device further to:
request a user selection of at least one selectable sub-item of the set of selectable sub-items; and
compare the user selection of at least one selectable sub-item with the label associated with the sub-item and a confidence metric associated with the label.

19. The system of claim 18, wherein the at least one selectable sub-item includes a portion of text or an object in an image.

20. The system of claim 11, wherein provide the at least one second electronic communication and the sub-item to a content moderation process causes the processing device to:
restrict an access of the user device to the sub-item; and
generate an escalation of review.
